(19) United States
(12) Patent Application Publication
(10) Pub. No.: US 2011/0309021 A1
(43) Pub. Date: Dec. 22, 2011

(54) MITIGATION OF IRRIGATION WATER USING ZERO-VALENT IRON TREATMENT

(76) Inventors: Yan JIN, Newark, DE (US); Pei Chiu, Hockessin, DE (US)

(21) Appl. No.: 13/166,358

(22) Filed: Jun. 22, 2011

Related U.S. Application Data
(60) Provisional application No. 61/357,304, filed on Jun. 22, 2010.

(51) Int. Cl. C02F 1/28; C02F 1/58; C02F 1/72

(52) U.S. Cl. 210/660; 210/282; 210/807; 210/170.01

(57) ABSTRACT

In one embodiment, this invention relates to a treatment for irrigation water by removing microbiological impurities and DBP precursors, utilizing filtration media comprising zero-valent metal to retain and inactivate microbiological agents such as viruses and bacteria such as Escherichia coli. One of the objectives of the present invention is to remove microbiological agents such as E. coli O₁₅₇:H₇ and Salmonella from irrigation water.

### CROSS-REFERENCE TO RELATED APPLICATION

This application claims priority to the U.S. Provisional Application No. 61/357,304; filed Jun. 22, 2010, which is incorporated by reference herein in its entirety.

### FIELD OF INVENTION

This invention relates to a treatment for irrigation water by removing microbiological impurities, and DBP precursors, utilizing filtration media comprising zero-valent metal to retain and inactivate microbiological agents such as viruses and bacteria such as Escherichia coli.

### BACKGROUND

Significant problems have occurred in the U.S. with regard to the contamination of produce by pathogenic bacteria such as Escherichia coli O₁₅₇:H₇ and Salmonella. Minimally processed produce lacks the processing and preparation hurdles, such as cooking, to reduce or eliminate contamination that can lead to widespread outbreaks and national product recalls. Greater emphasis has been placed on pre-harvest Good Agricultural Practices and post-harvest Good Manufacturing Practices. But the American food production and distribution system is vast and complex and such steps may not be adequate to address the contamination problem. For example, environmental fecal contamination is not uncommon in these foods, and transmission of human pathogens to plants through contaminated irrigation water has been documented under both laboratory and field conditions.

The consumption of contaminated foods is now a predominant mode for the transmission of human enteric pathogens which are increasingly being recognized as a significant public health risk. Approximately 76 million Americans are affected each year by food-borne illness, many of which are unreported and from unknown causes. Contamination of food can occur at pre-harvest from irrigation water as farmers are forced to use available water supplies which may include surface or ground waters. Outbreaks from fresh produce have reportedly increased by 295% between 1990 and 2001 (Roebuck, 2004). Fresh fruits and vegetables are commonly consumed in their raw state without processing to reduce or eliminate pathogens; therefore, managing the manner in which they are grown is crucial to minimize microbial contamination. E. coli O₁₅₇:H₇ has been involved in many outbreaks in the U.S. with estimates of 110,000 infections, 3,200 hospitalizations and 61 associated deaths occurring annually. The number of outbreaks linked to fresh produce and reported to the U.S. Centers for Disease Control and Prevention (CDC) has increased during the past 15 years. For example, in 2006, an outbreak of E. coli O₁₅₇:H₇ was linked to consumption of fresh, bagged, baby spinach with 26 states and Canada reporting 205 cases of illness and three deaths. Another E. coli O₁₅₇:H₇ outbreak associated with shredded lettuce resulted in 71 cases, 53 hospitalizations and 8 cases of hemorrhagic uremic syndrome. The shredded lettuce outbreak was traced back to the use of irrigation water contaminated with E. coli O₁₅₇:H₇. In both outbreaks, produce contamination was suspected to have occurred on the farm on which the produce was grown. Persistence of E. coli O₁₅₇:H₇ in the field depends on numerous factors. In general, E. coli O₁₅₇:H₇ survival in soil is enhanced in the rhizosphere, at low temperatures, and in clay soils. The presence of competing microorganisms may contribute to survival of E. coli in the field.

It is now established that fresh fruits and vegetables are major sources of food-borne disease causing about 5 to 23% of the identified cases of food borne diseases in many countries including the U.S. Of these, Salmonella enterica is one of the most common pathogens, accounting for about half of the outbreaks linked to fresh produce in the U.S. Salmonella-related outbreaks have been associated with the consumption of fruits, vegetables, sprouts and leafy vegetables. According to a recent analysis of food-borne outbreaks by the Center for Science in the Public Interest, produce now competes with poultry as a major vector of Salmonella infections. Moreover, fresh-food outbreaks tend to be larger and affect more people, sometimes hundreds or thousands at a time. This escalation in cases appeared in parallel with the sharp increase in the consumption of fruits and vegetables and the expanded consumption of minimally processed ready-to-eat salads. The economic impact of these outbreaks can be huge; for example, twenty years ago salmonellosis led to annual economic losses of up to $3.4 billion in the U.S. and Canada, long before the more recent nationwide produce recalls.

Economic impact can be significant in countries that export fresh produce. In 2007 more than 40 cases of Salmonella Senftenberg were reported in the UK, Scotland, Denmark, the Netherlands and the U.S. This outbreak was linked to fresh basil imported from Israel, and resulted in withdrawal of Israeli basil from UK markets. In 2006, Denmark also experienced a combined outbreak of E. coli and Salmonella Anatum, the likely source of this outbreak was again imported basil. In 2008, the California Leafy Green Marketing Agreement Irrigation water standards applied to foliar surfaces of leafy green crops in the California Leafy Green Marketing Agreement proposed levels that cannot exceed an average of 126 CFU or MPN E. coli/100 mL among five samples taken over 30 days. No single sample may contain greater than 235 MPN E. coli/100 mL.

Transmission of human pathogens to plants through contaminated irrigation water has been documented under both laboratory and field conditions. It is well-established that pathogenic microorganisms present in surface water and well-water continue to pose a threat to public health. Sources of waterborne human pathogens include, but are not limited to, landfills, wastewater discharge, land-disposed wastewater sludge, leaking sewer lines and failed septic systems, as well as runoffs and infiltrates from fields receiving animal waste. The EPA Science Advisory Board cited water contamination as one of the highest environmental risks, and microbiological contaminants (bacteria, viruses and protozoa) as the greatest remaining health risk management challenge for drinking water suppliers. The illnesses that result from exposure to microbial pathogens often rang from mild diarrhea that lasts a few days to severe infections that last several weeks, but may cause deaths in the sensitive sub-populations such as young children, the elderly, and people with compromised immune systems. During the incubation and infection process, infected individuals can shed pathogens in fecal material, including more than hundreds of bacteria, viruses, and protozoan oocysts per gram of feces. Therefore, source water contamination increases the loading of infective agents to water treatment systems.

### SUMMARY OF INVENTION

In one embodiment, the present invention relates to a device for treating irrigation water to reduce microbiological impurities and DBP precursors, said device comprising a first end, a second end, and a hollow space in between said first end and said second end, wherein said hollow space comprises filtration media, wherein said filtration media comprises:
(A) optionally, a base filtration medium; and
(B) zero-valent metal, wherein said zero-valent metal comprises granular zero-valent metal, and/or at least a partial coating of said zero-valent metal particles on at least some of said base filtration medium;
wherein, said first end and said second end of said device comprise means for making a connection with an irrigation water delivery device and/or a sprinkler system, and
   wherein said zero-valent metal is selected from the group consisting of iron, aluminum, and combinations thereof.

This invention also relates to a process for treating irrigation water to remove microbiological impurities, comprising the steps of:
(A) contacting said irrigation water with filtration media, wherein said filtration media comprises a metal;
(B) using the treated irrigation water from step (A) for irrigation;
wherein said metal is selected from the group consisting of iron, aluminum, and combinations thereof.

This invention also relates to a process for treating irrigation water as recited above, wherein said contacting of said irrigation water with said filtration media is accomplished by passing said irrigation water through a device for treating irrigation water, said device comprising a first end, a second end, and a hollow space formed in between said first end and said second end, wherein said hollow space comprises filtration media, wherein said filtration media comprises:
(A) optionally, a base filtration medium; and
(B) zero-valent metal, wherein said zero-valent metal comprises granular zero-valent metal, and/or at least a partial coating of particles said zero-valent metal on at least some of said base filtration medium;
wherein, said first end and said second end of said device comprise means for making a connection with an irrigation water delivery device and/or a sprinkler system, wherein said zero-valent metal is selected from the group consisting of iron, aluminum, and combinations thereof.

This invention further relates to a disinfection system for treating irrigation water to reduce microbiological impurities and DBP precursors, said disinfection system comprising:
(A) at least one device for treating irrigation water, said at least one device for treating irrigation water comprising a first end, a second end, and a hollow space formed in between said first end and said second end, wherein said hollow space comprises filtration media, wherein said filtration media comprises:
   (I) optionally, a base filtration medium; and
   (II) zero-valent metal, wherein said zero-valent metal comprises granular zero-valent metal, and/or at least a partial coating of particles of said zero-valent metal on at least some of said base filtration medium;
   wherein, said first end and said second end of said device comprise means for making a connection with an irrigation water delivery device and/or a sprinkler system, wherein said zero-valent metal is selected from the group consisting of iron, aluminum, and combinations thereof;
(B) an irrigation water delivery device, and
(C) optionally, at least one sprinkler at the end of said device for treating irrigation water from which treated irrigation water is dispensed on to the vegetation or field requiring irrigation water.

### DRAWINGS

FIG. 1. Removal of E. coli O₁₅₇:H₇ Over Time

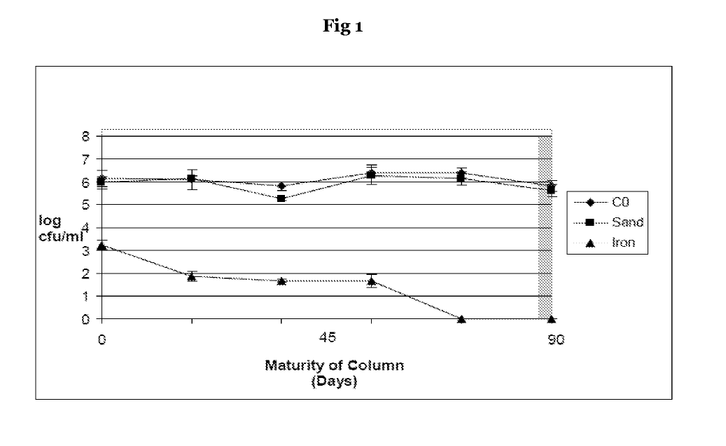

An increase in the removal and inactivation of E. coli O₁₅₇:H₇ was observed in this single column as it evolved over time. The ZVI column became more effective at reducing E. coli O₁₅₇:H₇ from an initial 2.72±0.06 log cfu/ml reduction to 5.62±0.28 log cfu/ml, or complete inactivation below the detection limit. At this latter stage, no viable cells were detected by enrichment. E. coli O₁₅₇:H₇ DNA was detected in the ZVI by polymerase chain reaction.

FIG. 2. ZVI Makes up 40% of the Overall Column Volume

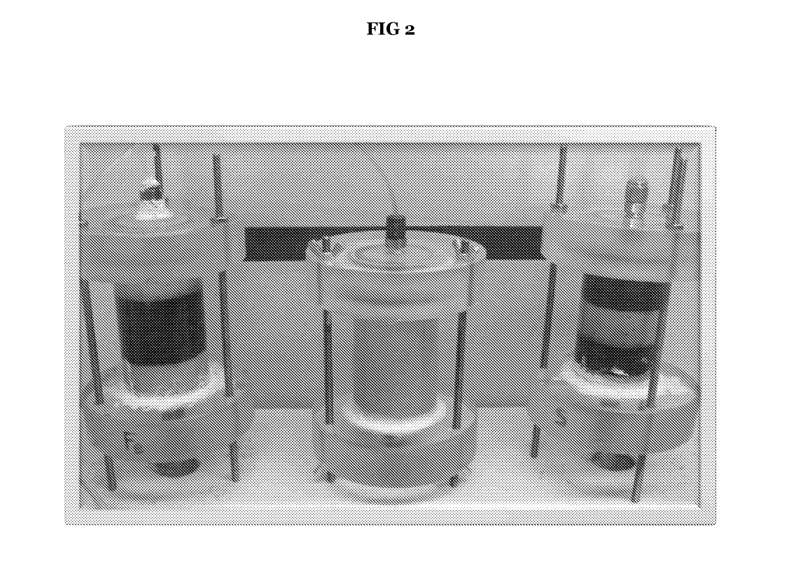

Sand is being compared to two ZVI-containing columns. The layer of sand in between 2 ZVI-containing layers may increase the removal of bacteria.

FIG. 3. Biosand Filters (BSF) are Being Used to Scale up the Laboratory Columns

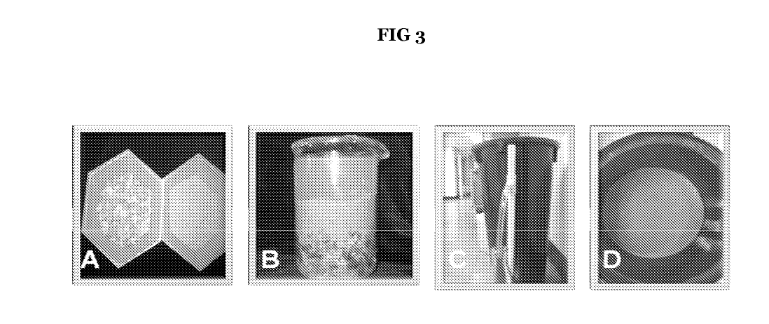

BSF (C and D) use gravel and sand (A and B) for commercial filtration of drinking water. ZVI IS incorporated into BSF and used on leafy greens grown in high tunnel greenhouses.

FIG. 4. Sample Collection and MACN Enumeration

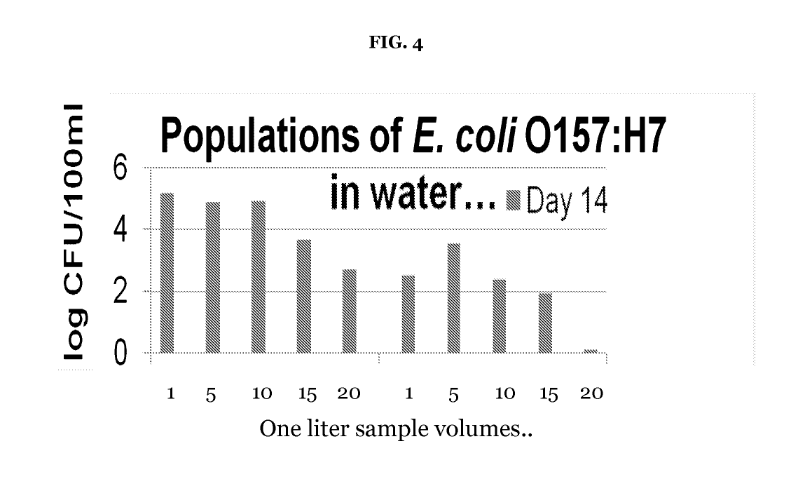

Water containing 8 log CFU/100 ml E. coli O₁₅₇:H₇ was introduced to the BSF on day 0, 8, 9, and 10. Samples were collected on days 14 and 15 by pulsing uninoculated irrigation well water (20 L) through the filter each day. Populations were enumerated on MacConkey agar supplemented with nalidixic acid (MACN).

FIG. 5. Microbial Analysis of Fluorescent E. coli O₁₅₇:H₇ in Water Filtered Through Biosand Filters

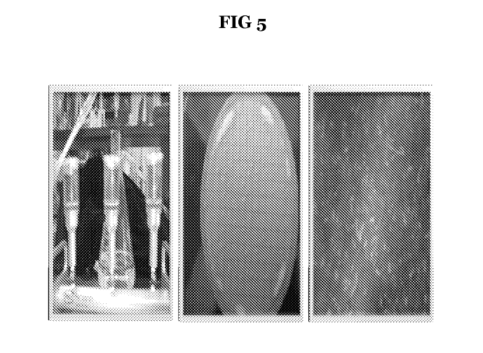

(A) Collection of E. coli O₁₅₇:H₇ on filters from BSF.

(B) E. coli O₁₅₇:H₇ on 0.45 um filter and MACN.

(C) Confirmation of fluorescent E. coli O₁₅₇:H₇ from filters.

FIG. 6

Prototype device for use in irrigation systems.

### DESCRIPTION OF THE INVENTION

### (I) Definitions and Explanations

All percentages expressed herein are by weight of the total weight of the composition unless expressed otherwise.

All ratios expressed herein are on a weight:weight (w/w) basis unless expressed otherwise. Ranges are used herein in shorthand, so as to avoid having to list and describe each and every value within the range. Any appropriate value within the range can be selected, where appropriate, as the upper value, lower value, or the terminus of the range.

As used herein, the singular form of a word includes the plural, and vice versa, unless the context clearly dictates otherwise. Thus, the references “a”, “an”, and “the” are generally inclusive of the plurals of the respective terms. For example, reference to “a method”, or “a food” includes a plurality of such “methods”, or “foods.” Likewise the terms “include”, “including” and “or” should all be construed to be inclusive, unless such a construction is clearly prohibited from the context. Similarly, the term “examples,” particularly when followed by a listing of terms, is merely exemplary and illustrative and should not be deemed to be exclusive or comprehensive.

The term “comprising” is intended to include embodiments encompassed by the terms “consisting essentially of” and “consisting of”. Similarly, the term “consisting essentially of” is intended to include embodiments encompassed by the term “consisting of.”

By “a and/or b” is meant that either “a” is present, or “b” is present, or both “a and b” are present.

The methods and compositions and other advances disclosed herein are not limited to particular equipment or processes described herein because, as the skilled artisan will appreciate, they may vary. Further, the terminology used herein is for the purpose of describing particular embodiments only, and is not intended to, and does not, limit the scope of that which is disclosed or claimed.

Unless defined otherwise, all technical and scientific terms, terms of art, and acronyms used herein have the meanings commonly understood by one of ordinary skill in the art in the field(s) of the invention, or in the field(s) where the term is used. Although any compositions, methods, articles of manufacture, or other means or materials similar or equivalent to those described herein can be used in the practice of the present invention, the preferred compositions, methods, articles of manufacture, or other means or materials are described herein.

All patents, patent applications, publications, technical and/or scholarly articles, and other references cited or referred to herein are in their entirety incorporated herein by reference to the extent allowed by law. The discussion of those references is intended merely to summarize the assertions made therein. No admission is made that any such patents, patent applications, publications or references, or any portion thereof, are relevant, material, or prior art. The right to challenge the accuracy and pertinence of any assertion of such patents, patent applications, publications, and other references as relevant, material, or prior art is specifically reserved.

The following definitions as used in the Specification of the present invention:

The terms “microbial pathogens,” “microbe,” “microorganism,” “microbial agent,” “microbiological agent,” and “biological agent” may be interchangeably used throughout the instant disclosure and connote a living organism or non-living biological agent typically too small to be seen with the naked eye; including bacteria, fungi, protozoa, microscopic algae, and biological remnants. It also includes viruses and prions. Such impurities are broadly termed here as “microbiological impurities.” Other impurities include disinfection by-products (DBPs) and disinfection by-product precursors (DBP precursors).

By “removing” or “reducing” microbiological impurities and DBP precursors is meant that such microbiological impurities and DBP precursors are removed from the irrigation water that has been treated by metal and particularly zero-valent (ZV) metal.

By ZV metal is meant:
(1) granular ZV metal, that is, granular metal particles not coated on any filtration or other media, and/or
(2) nano-sized zero-valent (NSZV) metal-coated filtration medium, and/or
(3) micro-sized zero-valent (MSZV) metal-coated filtration medium.

By ZVI is meant:
(1) zero-valent iron that includes granular iron (that is, granular iron not coated on any filtration or other media), and/or
(2) nano-sized zero-valent iron (NSZVI)-coated filtration medium, and/or
(3) micro-sized zero-valent iron (MSZVI)-coated filtration medium.

The reactivity of the microbiological impurities and DBP precursors to ZV metal is reduced as a result of the treatment of water by the ZV metal, or they have been inactivated as a result of the treatment of water by the ZV metal.

The terms “microbiological impurities and DBP removing agent,” “microorganism-removing agent,” “microbial pathogen-removing agent,” “microbe-removing agent,” etc., as used herein, mean ZV metal that is capable of forming a metal oxide, hydroxide, and/or oxyhydroxide through corrosion or any other mechanism. It can also mean ZV metal that comprises a metal oxide, metal hydroxide, and/or metal oxyhydroxide formed on its surface.

“Filtration medium” and “filtration media” are used interchangeably, and mean one or more media used for filtration. Whether one term is used or the other, both meanings, that of singular (medium) and plural (media) are implicated unless specifically indicated otherwise.

By coating of the filtration media with NSZV and/or MSZV metal is meant that such media are fully- or partially coated with the NSZV and/or MSZV metal particles. A filtration media particle (if the filtration media is in granular form) can be completely coated, that is, substantially, no surface of the particle is exposed. If all filtration media particles are completely coated, then the filtration media is called “fully-coated” with the NSZV and/or MSZV metal.

If filtration media particles are not fully-coated, they are partially-coated. For example, “partial coating” for a given set of NSZV and/or MSZV metal-coated filtration media particles can mean:
(1) all filtration media particles are coated, but are only partially-coated; or
(2) some filtration media particles are partially-coated, and/or some are not coated at all, and/or some are completely-coated.

U.S. Patent Publication No. 20060249465 that relates to the U.S. patent application Ser. No. 11/375,206 is incorporated by reference herein in its entirety. Similarly, U.S. patent application Ser. No. 12/964,998 is also incorporated by reference in its entirety.

### (II) Process for Removing Microbiological Impurities From Irrigation Water

In one embodiment, this invention relates to a process for treating irrigation water to remove microbiological impurities, comprising the steps of:
(A) contacting said irrigation water with filtration media, wherein said filtration media comprises a metal;
(B) using the treated irrigation water from step (A) for irrigation;
wherein said metal is selected from the group consisting of iron, aluminum, and combinations thereof.

This invention further relates to the above process wherein said contacting of said irrigation water with said filtration media is accomplished by passing said irrigation water through a device for treating irrigation water. The device for treating irrigation water is described infra in the present disclosure.

In the above process, said metal is capable of forming oxide, hydroxide, and/or oxyhydroxide. In another embodiment, the above process also includes filtration media comprising said metal with an oxide, hydroxide, and/or oxyhydroxide coating having charged surface sites on said metal surface through corrosion in water. The charged metal surface is net-positive or net-negative and the invention successfully removes microbiological impurities and DBP precursors from irrigation water in either case of surface charge. In a preferred embodiment, the metal is zero-valent iron. Said zero-valent metal (iron for example) can be NSZV and/or MSZV or granular metal.

Generally, in the above process for treating irrigation water, the metal such as the ZV metal, is in contact with said irrigation water to be treated for a time of about 0.1 second or more. The contact time could be from 1 to 60 seconds, for example 1, 2, 3, 4, 5, 6, . . . 57, 58, 59, and 60 seconds; from 1 minute to 60 minutes, for example, 1, 2, 3, 4, 5, 6, . . . 57, 58, 59, and 60 minutes; and from 1 hour to 24 hours, for example, 1, 2, 3, 4, . . ., 22, 23, and 24 hours. The contact time could be more than 1 day, for example, 2 days, 3 days, 4 days, 5 days, 6 days, and so on.

In one aspect of the invention described above, said metal is capable of forming oxide, hydroxide, and/or oxyhydroxide. In another aspect, the process for irrigation water treatment is performed with said filtration media comprising said metal with an oxide, hydroxide, and/or oxyhydroxide coating.

In a preferred embodiment, in the process for treating irrigation water as recited above, said metal is zero-valent iron.

In another embodiment of the process for treating irrigation water described above, said base filtration medium is at least partially coated with NSZV and/or MSZV metal particles wherein said NSZV metal particles are in a size range of from about 1 to about 1,000 nm and said MSZV metal particles are in a size range of from about 1 to about 200 micron.

In yet another embodiment of the process for treating irrigation water described above, said filtration media comprises a base filtration medium that is fully-coated with NSZV and/or MSZV particles.

In a further embodiment of the process for treating irrigation water described above, said irrigation water comprises a virus and said treatment reduces said virus content by at least about 50%.

In one embodiment of the process for treating irrigation water described above, said irrigation water comprises bacteria and said treatment reduces said bacteria content by at least about 50%.

The above described process can also be performed in conjunction with one or more other disinfection processes currently available, such as chemical disinfection, irradiation, and filtration. In a preferred embodiment, the present invention relates to a process for reducing the use of a chemical disinfectant, irradiation, and/or filtration used to disinfect irrigation water, comprising, treating said irrigation water sought to be disinfected with iron capable of forming an oxide, a hydroxide, and/or an oxyhydroxide such that said chemical disinfectant can be decreased and/or eliminated without a negative change in efficacy of said disinfection of said water. In another preferred embodiment, the present invention relates to process for reducing the use of a chemical disinfectant, irradiation, and/or filtration used to disinfect irrigation water, comprising, treating said irrigation water sought to be disinfected with iron having an oxide, a hydroxide, and/or an oxyhydroxide such that said chemical disinfectant can be decreased and/or eliminated without a negative change in efficacy of said disinfection of said water.

### (III) Filtration Media

The filtration media used in the present invention, in one embodiment, comprises metal as discussed previously. The metal can be iron or aluminum or combination thereof. Iron is preferred.

In one aspect of the present invention, zero-valent metal, and particularly, zero-valent iron (ZVI)—which includes zero-valent iron (ZVI) particles of 0.2 to 2.0 mm, and/or NSZVI, and/or MSZVI coated base filtration media—is incorporated with base filtration media as an active medium to enhance microbial removal, as discussed below.

In one embodiment of the invention, the microbiological impurities and DBP precursor-removing agent is granular ZV metal. In another embodiment of the invention, the microbiological impurities and DBP precursor-removing agent is NSZV metal. In yet another embodiment of the invention, the microbiological impurities and DBP precursor-removing agent is MSZV metal. In yet another embodiment, the microbiological impurities and DBP precursor-removing agent comprises at least one of granular ZV metal, NSZV metal, and MSZV metal. In a preferred embodiment the granular ZV metal, the NSZV metal, and/or MSZV metal is iron. In another embodiment, at least one of the granular ZV metal, NSZV metal, and MSZV metal is iron and/or aluminum, and/or combinations thereof. For example, in one embodiment the granular metal could be iron and aluminum, and/or the NSZV could be iron and aluminum and/or the MSZV could be iron and aluminum. Iron and aluminum can be found on a one type of base filtration media particles or on different type base filtration media particles in the same device. Base filtration media particles are discussed infra.

In one embodiment of the present invention, the base filtration media comprise at least one of anthracite, sand, gravel, activated carbon, zeolite, clay, diatomaceous earth, garnet, ilmenite, zircon, charcoal, and ion exchange resin, silica gel, titania, carbon black, and mixtures thereof. Other uncoated filtration medium include all es of membrane filters, paper filters, sponges, nets, and fibers.

In one embodiment, ZVI oxidizes continuously in irrigation water through reactions with dissolved oxygen and protons to form amorphous iron hydroxides which are subsequently converted into more stable oxides and oxyhydroxides, such as magnetite, goethite, and lepidocrocite. Iron hydroxides, oxides, and oxyhydroxides have a relatively high pH_{pzc} (point of zero charge) and can strongly adsorb viruses and other negatively charged microorganisms possible via electrostatic interactions. The adsorption of viruses, for example, to iron (hydr)oxide surface is followed by inactivation of the adsorbed viruses via strong attachment forces, rendering the viruses disintegrated and non-infective. One can envision that as irrigation water flows through porous media containing ZVI, new surface sorption sites are constantly produced as ZVI reacts, and viruses and other contaminants are continuously removed from water. The discussion of the above theory does not limit the invention to this theory only. The theory is only one aspect of the present invention.

ZVI may serve as a disinfection technology in water treatment plants to help accomplish disinfection goals without significant modification or replacement of existing treatment systems. For example, ZVI granules may be incorporated into sand or mixed-media filters to enhance virus removal. This process is not based on chemical oxidants (chlorine, ozone, chlorine dioxide and chloramines) and thus does not generate disinfection by-products. Unlike granular and membrane filtration, the method is not based on physical trapping and therefore does not require small pores or particle sizes. Furthermore, ZVI offers the added benefit of removing chemical contaminants and other undesirable constituents in water, including natural organic matter.

In one aspect of the invention, zero-valent iron (ZVI) in mixtures with sand, in a flow-through column effectively and rapidly removes E. coli O₁₅₇:H₇ and Salmonella from contaminated irrigation water.

One aspect of the invention relates to design and evaluation of ZVI columns to remove bacterial pathogens taking various irrigation water conditions into consideration. Bacterial cells that survive ZVI treatment are assessed for survival and attachment to lettuce as if irrigated with ZVI-treated water. In another aspect of the invention, ZVI columns are scaled-up and built into irrigation systems that are currently used in high tunnels, greenhouses and growth chambers. These systems are used to water leafy greens and assess for bacterial survival.

In one aspect, this invention relates to high-volume treatment of irrigation water utilizing filtration through columns of mixtures of zero-valent iron (ZVI) and sand. The ZVI process is not based on a chemical oxidant such as chlorine and therefore, generally, does not generate disinfectant by-products.

(IV) NSZV and/or MSZV Metal-Coated Filtration Media

NSZV metal particles, due to their small size, exhibit much higher specific surface area (for example, 20-50 m²/g) and correspondingly higher activity or reactivity than regular zero valent metals. Thus, in one embodiment, the NSZV metal particles can be in the range of from about 1 rim to about 1,000 nm. In one embodiment, the NSZV metal particle size is about 1 nm, about 2 nm, about 3 nm, about 4 nm, . . ., about 998 nm, about 999 nm, or about 1,000 nm. The NSZV metal particles when deposited on a filtration media (alternatively called the base filtration media) particle can be found as individual particles deposited on the filtration media particle or as clusters (more than one particles found in close proximity) of NSZV metal particles deposited on the base filtration media particle. The particle sizes of different NSZV metal particles as deposited on the base filtration media can vary in size and shape.

Similarly, in one embodiment, the MSZV metal particle size is about 1 micron to 200 micron, that is about 1 micron, about 2 micron, about 3 micron, about 4 micron, . . . , about 198 micron, about 199 micron, or about 200 micron. The MSZV metal particles when deposited on the base filtration media particle can be found as individual particles deposited on the filtration media particle or as clusters (more than one particle found in close proximity) of MSZV metal particles deposited on the base filtration media particle. The particle sizes of different MSZV metal particles as deposited on the base filtration media can vary in size and shape.

In one embodiment, NSZV and/or MSZV metal is deposited onto granular activated carbon (GAC) and ion-exchange resin for point-of-use (POU) systems/device described herein. For this application, advantage is taken of: (1) the high surface area and activity or reactivity of NSZV and/or MSZV metal (and thus small NSZV and/or MSZV metal mass is needed), and (2) the ability of NSZV and/or MSZV metal to remove disinfectants (e.g., chlorine) and to remove/inactivate viruses and bacteria in water (microbiological impurities).

Generally, in one embodiment of the process of the invention, a small percentage of the surfaces of GAC and resin is coated with NSZV and/or MSZV metal.

In one embodiment, for example, with the NSZV and/or MSZV metal as iron (NSZVI and/or MSZVI), the NSZVI and/or MSZVI content can be varied from about 0.2% to about 35% by weight. While GAC and ion-exchange resin are used for exemplary purposes, the NSZV and/or MSZV metal-coating can be accomplished on other filtration media identified herein.

NSZVI and/or MSZVI have a higher surface area (10-100×) and activity or reactivity than regular (mm-size) zero-valent iron (ZVI). Thus, only a small weight percent of NSZVI and/or MSZVI is needed to provide significant contaminant removal. The small NSZVI and/or MSZVI mass used also alleviates the potential concerns of iron getting into filtered water.

No existing systems address the problem of microbiological impurities and DBP precursor removal from irrigation water. The present invention provides a first point-of-use device to remove such impurities. NSZVI and/or MSZVI of the instant invention can also remove As (especially As^{V}), Cr^{VI}, U^{VI}, other metals, and many organic chemicals including haloacetic acids and other DBPs and DBP precursors.

In one aspect, the present invention relates to using elemental metal to remove microbial pathogens from irrigation water because elemental metal can continuously generate and renew the surface oxides, hydroxides, and/or oxyhydroxides through corrosion or any other mechanism in water, and that such metal oxides, hydroxides, and/or oxyhydroxides remove microbial pathogens from water.

Zero-valent elemental metal means that the elemental metal substantially has a valence of zero, for example, a zero-valent iron would be designated as Fe^{o}. The base filtration medium (uncoated) is a filtration medium that is generally used for filtration of water. In one aspect, the filtration medium is granular, consisting of granular matter from about several microns to several millimeters.

In one aspect of the invention, if the filtration medium is a granular filtration medium, the number of filtration medium particles coated with the NSZV and/or MSZV metal, from a set of given number of filtration medium particles is in the range of from about 0.5% to about 35.0%. In another range for this invention, the number of particles coated is in the range of from about 1.0% to about 35.0%. Similarly, the lower limit of such ranges, or the upper limit of such ranges, include numerical percentage values selected from the following numbers: 1.0%, 1.5%, 2.0%, 2.5%, 3.0%, 3.5%, . . . 33.0%, 33.5%, 34.0%, and 34.5%.

In this aspect of the invention, the percentage of the total available coatable filtration medium surface area that is coated with the NSZV and/or MSZV metal is in the range of from about 0.25% to about 35%. It is possible that a given particle may be partially-coated or fully-coated. However, in this aspect of the invention, whether a given particle is partially coated or fully coated, the overall percentage of the filtration medium coated, as measured by its BET surface area is from about 0.25% to about 35%. In another range for this invention, the percent coating is from about 0.5% to about 35% of the total available coatable surface area of the filtration medium particles. Similarly, the lower limit of such ranges, or the upper limit of such ranges, include numerical percentage values selected from the following numbers: 0.5%, 0.75%, 1.00%, . . . , 34.00%, 34.25%, 34.50%, and 34.75%.

In another aspect of the invention, the weight percent of the NSZV and/or MSZV metal as coated on the filtration medium is in the range of from about 0.2% to about 35%. The density of any elemental metal will generally be higher than the uncoated filtration medium. In another range for this aspect of the invention, the weight percent of the NSZV and/or MSZV metal as coated on the filtration medium is in the range of from about 0.2% to about 35%. Similarly, the lower limit of such ranges, or the upper limit of such ranges, include numerical percentage values selected from the following numbers: 0.3%, 0.4%, 0.5%, . . . , 34.0%, 34.4%, 34.6%, and 34.8%.

In one embodiment, the NSZV and/or MSZV metal is coated at discrete locations on the surface of the filtration media particles. Stated another way, in this embodiment, the NSZV and/or MSZV metal-coated on the filtration media and the uncoated filtration media can treat the water simultaneously.

The uncoated filtration media or the base filtration media can be one or more of the filtration media known to a person skilled in the art. More than one type of filtration media can be blended in a “salt-and-pepper” configuration. If there are more than one filtration media, in one aspect of the invention, at least one of the filtration medium is coated with the NSZV and/or MSZV metal. Within each type of filtration medium, if coated, the above range limitations apply. The above range limitations also apply to the overall filtration medium.

In one embodiment, the NSZV and/or MSZV metal-coated filtration media particles can be found in a singular layer at the top and/or the bottom of the filtration media.

In another embodiment, the NSZV and/or MSZV metal-coated filtration media particles may or may not be in a singular layer at the top and/or at the bottom. However, in this embodiment, within the body of the filtration media, there is at least one layer that is the NSZV metal-coated filtration media particles. These intermediate layers (or the single layer at the top and/or the bottom) may or may not be a salt-and-pepper blend with non-coated, same or different, filtration media, or NSZV and/or MSZV metal-coated different filtration media.

In yet another embodiment, the first NSZV and/or MSZV metal-coated filtration media is mixed with one or more, second NSZV and/or MSZV metal-coated filtration media in a singular layer at the top and/or the bottom, and/or in the intermediate layers.

In one embodiment, one or more than one type of filtration media are coated with one or more than one type of NSZV and/or MSZV metal. Even with this mixed filtration media and mixed metals, the above ranges apply as a combined metal and combined filtration media weight.

### (V) Irrigation Water Treatment Systems and Devices

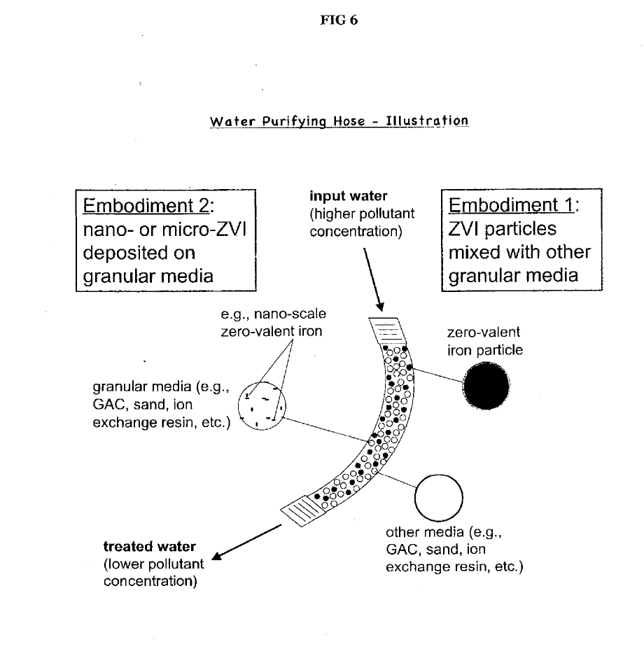

One embodiment of the invention relates to device for treating irrigation water by removing microbiological impurities and DBP precursors, and DBPs. The device can be an enclosed chamber such as a hose, a tubular device, a canister or even a flexible piece of tubing. The device comprises of a connector or connection means on each end (for example, either a male and a female, or two snap-on quick connectors), and can be inserted readily into any existing piping system. The device is filled with granular media (base filtration media) for purifying water. The type of media used can be tailored depending on the specific application and the contaminants to be removed. For example, for irrigation or food-/produce processing purposes, granular ZVI and/or NSZVI and/or MSZVI coated base filtration media particles are added as a component to remove viruses, bacteria, protozoa, and other biological or chemical contaminants (e.g., algae, spores, arsenic, pesticides, organic matter, etc.) from water. A schematic illustrating two possible methods of incorporating ZVI into the proposed water purifying hose is shown in FIG. 6. In a preferred embodiment, the device may be substantially leak-proof once fitted within the flow of irrigation water.

A device for treating irrigation water as described above could be bought at hardware stores, nurseries, gardening and other supply stores. It could also be something farmers and produce- and food processing companies would use to remove microbial pathogens and other undesirable constituents from water.

The device for treating irrigation water can be added prior to the point of use (e.g., before an irrigation sprinkler or before a shower head for washing leafy greens) to help safeguard water quality. Or it can be used elsewhere in a piping system to protect equipment downstream or enhance the overall quality of finished water. Based on each application, treatment need, allowable pressure drop, and water flow-rate, one can choose media that have suitable functions, particle size, and rigidity, as well as tubing of appropriate length and diameter. For example, for a gravity-fed irrigation system, a hose of relatively large diameter and medium particle size may be used (the hose can be connected to existing pipes via reducers) in order to accommodate the limited available pressure head. A user may connect two or more hoses containing different media for specific treatment needs, and replace media in a particular hose when the media are spent.

In one embodiment, this invention relates to a disinfection system to reduce microbiological impurities and DBP precursors from irrigation water, said disinfection system comprising:
(A) at least one device, said at least one device comprising a first end, a second end, and a hollow space formed in between said first end and said second end, wherein said hollow space comprises filtration media, wherein said filtration media comprises:
   (I) optionally, a base filtration medium; and
   (II) zero-valent metal, wherein said zero-valent metal comprises granular zero-valent metal, and/or at least a partial coating of particles said zero-valent metal on at least some of said base filtration medium;
   wherein, said first end and said second end of said device comprise means for making a connection, for example, a substantially leak-proof connection, with an irrigation water delivery device and/or a sprinkler system, wherein said zero-valent metal is selected from the group consisting of iron, aluminum, and combinations thereof;
(B) an irrigation water delivery device, and
(C) optionally, at least one sprinkler at the end of said device for treating irrigation water from which treated irrigation water is dispensed on to the vegetation or field requiring irrigation water.

By irrigation water delivery device is meant any delivery mechanism used for delivering irrigation water to vegetation, fields, etc., where irrigation water is required. Such devices include irrigation hose, a pipe or a flexible tube, or any other system, generally enclosed. But this invention does not preclude treating running or even stationary irrigation water that may be open to outside environment. For example, the present invention envisions treating standing irrigation water that may be gravity-fed to the irrigation water treatment system described herein. For example a system of the present invention can be installed below the container of irrigation water for treatment prior to use.

In an embodiment of the system for treating irrigation water described above, said base filtration medium is at least partially coated with NSZV and/or MSZV metal particles wherein said NSZV metal particles are in a size range of from about 1 to about 1,000 nm and said MSZV metal particles are in a size range of from about 1 to about 200 micron. Alternatively, in another embodiment, said filtration media comprises a base filtration medium that is fully-coated with NSZV and/or MSZV particles.

In one embodiment, in the system described above, from about 0.5% to about 35% of all said filtration media particles by number in said system are at least partially coated with NSZV and/or MSZV metal.

In yet another embodiment in the system described above, said base filtration medium is partially-coated, and the coated surface area of said filtration medium particles as a percentage of total available coatable filtration medium surface area of filtration medium particles in said system is in the range of from about 0.25% to about 35%.

In another embodiment, in the above described system, the amount of said NSZV and/or MSZV metal coated on said filtration medium, as a percentage of the total of said NSZV and/or MSZV metal and said base filtration medium in said system, is in the range of from about 0.2% to about 35%.

In one embodiment, in the system as described above, said NSZV and/or MSZV metal is zero-valent iron.

The metal content as percentage of the total filtration medium in a described supra, is in the range of from about 0.1% to about 99%. The metal content can be within a range defined by any two percent numbers from below. The endpoints of the range are also included within the range: 0.1, 0.2, 0.3, . . . 1.0, 1.1, 1.2, 1.3, . . . 98.7, 98.8, 98.9, and 99.0. The three dots in between the numbers above indicate that all numbers in between, integers or otherwise, separated from each other by 0.1 units are included herein for defining the ranges. Similarly, in other sections of this disclosure, where ranges are stated, the intermediate numbers are also included within this invention.

The device and process for treating irrigation water of the present invention can remove microbiological impurities and DBP precursors from water in an amount defined by any two numbers of the range given below. The numbers below are given as percentage of the total original concentration of the microbiological agents, or total original concentration the specific microbiological agent or agents in question. The endpoints of the range are also included within the range: 1, 2, 3, 4, 5, . . . 95, 96, 97, 98, 99, 99.1, 99.2, 99.3, 99.4, 99.5, 99.6, 99.7, 99.8, 99.9, 99.99, 99.999, 99.9999, 99.99999, 99.999999, 100.

In the above device of the invention, the filtration media comprise at least one of anthracite, sand, gravel, activated carbon, zeolite, clay, diatomaceous earth, garnet, ilmenite, zircon, charcoal, and ion exchange resin, silica gel, titania, carbon black, and mixtures thereof. Other uncoated filtration medium include all types of membrane filters, paper filters, sponges, nets, and fibers.

In one embodiment of the present invention, the net surface charge on the filtration media particles (the ZV metal, which includes granular ZV metal, NSZV and/or MSZV metal-coated base filtration media) within the above device of the invention housing the filtration media is net-positive. In another embodiment of the present invention, the net surface charge on the filtration media particles (the ZV metal, which includes granular ZV metal, NSZV and/or MSZV metal-coated base filtration media) within the above device of the invention housing the filtration media is net-negative. The net-positive charge can shift to net-negative charge depending upon the pH of the water being treated. The present invention can remove microbiological and DBP precursors and other impurities whether the net charge of the particles is positive or negative.

In another embodiment, the above system comprises more than one said device connected in series. In yet another embodiment, the above described disinfection system comprises more than one said device connected in parallel, and each said device is connected to a corresponding sprinkler.

The system of the present invention can be a continuous-flow system or a batch system. The system can also be portable.

### EXPERIMENTAL AND EXPERIMENTAL METHODS

inactivation is not necessarily based on physical trapping and therefore does not require small pore or particle size or incur significant pressure fluctuations.

The experimental objectives of this invention include: optimize the effectiveness of granular ZVI/sand water treatment columns by challenging with inocula from two serotypes of E. coli (O₁₅₇:H₇ and O₁₅₇:H₁₂) and Salmonella Newport. Experimental variables for examination include ratios of granular ZVI to sand in the treatment columns, the optimal age (e.g., level of oxidation) of columns needed to achieve maximum bacterial reduction, the effect of different levels of dissolved organic carbon in water on column effectiveness, and recovering E. coli and Salmonella with regard to temperature and survival from spot inoculation of foliar lettuce surfaces. Objectives also include incorporating granular ZVI columns into irrigation systems that are currently used in high tunnels and evaluating their effectiveness, and analyze leafy greens for surviving surrogates E. coli O₁₅₇:H₁₂ after irrigation with ZVI-treated water. E. coli O₁₅₇:H₁₂ is found in water contaminated with various sources of sterile feces (dairy cattle, pig, and poultry).

Another aspect of this invention relates to optimizing removal of E. coli O₁₅₇:H₇ and Salmonella from water treated by passage through ZVI-sand columns under conditions modeling commercial use.

ZVI water treatment columns are tested in the laboratory using two serotypes of E. coli (O₁₅₇:H_{7 4407} Spinach outbreak strain and O₁₅₇:H₁₂) and Salmonella Newport.

In the experiments, optimal age of columns to promote bacterial removal is determined. Also, the 1:1 and 3:1 ZVI:sand ratios columns are optimized. Also, three initial inoculum levels are tested to evaluate what could happen under different conditions, including a potential fecal spike (103,105, & 107 CFU/mL). also, three different levels of dissolved organic carbon in water are tested. Also, natural surface water (measurement of TPC and coliforms) is compared to one local source. The extent of injury of bacterial cells that survive the ZVI column is assessed using spot-inoculation onto foliar leaf surfaces.

In one aspect, a ZVI column is integrated into an irrigation water system into functional irrigation system used in high tunnels. Also, the fate of E. coli O₁₅₇:H₁₂ in water treated by a ZVI-column and applied to lettuce is evaluated.

Multiple identical acrylic columns are prepared (sand-only) and experimental (iron-sand mixture) columns that are wet-packed with well-characterized Accusand sand (Unimin Corp, Le Sueur, Minn.) of known particle-size distribution. The sand column serve as a control against microbial adsorption and inactivation by ZVI. One experimental (ZVI) column design includes a sand layer of 3 cm, followed by a 7 cm layer of 50:50 mixture of sand and sieved granular ZVI (Peerless Metal Powders and Abrasive, Detroit, Mich.). Depending on the layering, the ratios are optimized. The inclusion of sand with the iron here ensures that the iron layer does not become compacted. The ZVI layer thickness and water flow rate are adjusted to give a desired constant residence time in both control and experimental columns, consistent with what can be used in the irrigation system. For each experimental design, the flow rate and retention time (time the organisms spend within the iron/sand layer) is characterized.

Water samples are collected and bacteria recovered using the Pathatrix immunomagnetic bead system. Bacterial survival is determined by plating on non-selective media and also by polymerase chain reaction. This provides information on the potential for survival in the field if bacteria survive the ZVI column. For E. coli O₁₅₇, the non-selective medium is Tryptic soy agar (TSA) supplemented with 0.6% yeast extract (TSAYE) and the selective medium is sorbitol MacConkey agar supplemented with cefixime tellurite selective supplement which gives recovery of only healthy cells. For S. Newport, TSAYE is also the non-selective plating medium, but TSA with 3% NaCl is the selective medium to determine the degree of injury.

In one aspect of the invention, optimized ZVI columns are incorporated into high-tunnel irrigation systems. High tunnels provide a protected environment for lettuce to be grown in the spring by providing adequate temperature and moisture requirements for lettuce plant. Irrigation systems in high tunnels supply well-water through polyvinyl chloride (PVC) pipes to an overhead sprinkler system. Two high tunnels are used: one for control (sand column), and the other for a ZVI column. Two sets of experiments are performed in the high tunnels. The first set of experiments adds low populations (103 CFU/ml) of E. coli O₁₅₇:H₁₂, in sterile animal feces, to irrigation water through the column to simulate a realistic environmental fecal contamination event. A water holding tank, along with the column, is added to the irrigation system prior to the location where the column is attached. Inoculum is added to the tank and then pumped through the column. Column-treated water is then collected in a tank. Water will be microbiologically analyzed before and after column treatments. Inoculated column-treated water will also be irrigated to lettuce plants using overhead-sprinklers in high tunnels. Collected water from tanks is analyzed before and after column treatments. Romaine lettuce plants irrigated with column-treated water are also analyzed on 0, 1, and 2 days after overhead irrigation treatments. Microbial analysis of water will occur by previously employed filter methods. MacConkey agar supplemented with nalidixic acid (MACN) is used to enumerate E. coli O₁₅₇:H₁₂ counts. Romaine lettuce leaves from 10 plants are collected, stomached, sonicated, and then analyzed for E. coli O₁₅₇:H₁₂ using a modified MPN method. Leaves are enriched in mEHEC broth and MPN are calculated on days 0, 1, and 2.

The second inoculation level (107 CFU/ml) is employed to ensure that there will be E. coli O₁₅₇:H₁₂ which survive the ZVI treatment. Inoculated water is pumped using electric pumps through types of columns in separate high tunnels. Inoculated water is then irrigated using overhead sprinkling on to Romaine lettuce plants. Leaves are analyzed on day 0, 2, 5, 7, 10, and 14 by either direct plating on MACN or by MPN method depending on the recovered level of bacteria. Sub-lethal injury of E. coli O₁₅₇:H₁₂ cells is determined as described above. E. coli O₁₅₇:H₁₂ is used as a non-pathogenic surrogate for E. coli O₁₅₇:H₇. High tunnels are not Biosafety level 2 facilities. Previous studies have evaluated E. coli O₁₅₇:H₁₂, originally isolated from a Baltimore County (MD) and real time PCR analysis revealed that it possesses no virulence properties of E. coli O₁₅₇:H₇. Furthermore, this isolate shows the same growth rate as E. coli O₁₅₇:H₇ in lettuce extracts, and can be recovered using similar enrichment and enumeration methods for E. coli O₁₅₇:H₇.

Produce growers often face uncertain conditions, including times of drought. Growers may be forced to utilize various types of water as well. The use of ZVI as discussed above is a simple technology that can remove pathogens from water. In one experiment, in laboratory columns containing a layer of iron and sand (1:1 ratio) is compared to a column completely filled with sand. These studies are performed similar to those above but on a smaller scale. Artificial ground water containing approximately five logs of hepatitis A virus is pulsed through both columns. Sand physically removes some pathogens. The removal efficiency of the iron containing column is consistently higher than that of the sand. Over three trials hepatitis A virus is removed from the water by the column containing ZVI. Virus inactivation and removal was determined using the TCID₅₀ assay and mammalian cell culture. Similar results are observed in studies utilizing E. coli O₁₅₇:H₇, assessing a cocktail of 5 strains. In laboratory scale columns of less than 10 days, 3 logs of bacteria are removed. Interestingly, as the column aged over 14 days, it exhibited different morphology from the younger columns On T-Soy agar plates, growing as very small pin-prick colonies, and do not grow on selective media (Sorbitol MacConkey). In subsequent tests preliminary results indicate that these colonies are less likely to be virulent in a Vero assay and are less likely to bind to spinach leaves compared to E. coli O₁₅₇:H₇ cells that were recovered from the sand column.

### Abbreviations

BET Brunauer-Emmett-Teller

CER Cation-exchange resin

CFU/ml Colony-forming unit per milliliter

GAC Granular activated carbon

MACN MacConkey agar supplemented with nalidixic acid

MSZV Micro-sized zero-valent

MSZVI Micro-sized zero-valent iron

NSZV Nano-sized zero-valent

NSZVI Nano-sized zero-valent iron

POU Point-of-use

TSA Tryptic soy agar

TSAYE Tryptic soy agar supplemented with 0.6% yeast extract

ZVI Zero-valent iron

ZV Metal Zero-valent metal

1. A device for treating irrigation water to reduce microbiological impurities and DBP precursors, said device comprising a first end, a second end, and a hollow space in between said first end and said second end, wherein said hollow space comprises filtration media, wherein said filtration media comprises:
(A) optionally, a base filtration medium; and
(B) zero-valent metal, wherein said zero-valent metal comprises granular zero-valent metal, and/or at least a partial coating of said zero-valent metal particles on at least some of said base filtration medium;
wherein, said first end and said second end of said device comprise means for making a connection with an irrigation water delivery device and/or a sprinkler system, and wherein said zero-valent metal is selected from the group consisting of iron, aluminum, and combinations thereof.

2. The device for treating irrigation water as recited in recited in claim 1, wherein said base filtration medium is selected from the group consisting of anthracite, sand, gravel, activated carbon, zeolite, clay, diatomaceous earth, garnet, ilmenite, zircon, charcoal, ion exchange resin, silica gel, titania, carbon black, and mixtures thereof.

3. The device for treating irrigation water as recited in claim 1, wherein said metal in said filtration media is in an amount effective to remove said microbiological impurities and DBP precursors from said irrigation water.

4. The device for treating irrigation water as recited in claim 1, wherein said zero-valent metal is capable of forming oxide, hydroxide, and/or oxyhydroxide.

5. The device for treating irrigation water as recited in claim 1, wherein said filtration media comprises said zero-valent metal with an oxide, hydroxide, and/or oxyhydroxide coating.

6. The device for treating irrigation water as recited in claim 1, wherein said zero-valent metal is zero-valent iron.

7. The device for treating irrigation water as recited in claim 1, wherein said zero-valent metal is zero-valent aluminum.

8. The device for treating irrigation water as recited in claim 1, wherein said base filtration medium is at least partially coated with NSZV and/or MSZV metal particles, wherein said NSZV metal particles are in a size range of from about 1 to about 1,000 nm and said MSZV metal particles are in a size range of from about 1 to about 200 micron.

9. The device for treating irrigation water as recited in claim 1, wherein said filtration media comprises a base filtration medium that is fully-coated with NSZV and/or MSZV particles.

10. The device for treating irrigation water as recited in claim 8, wherein said filtration media is partially-coated, and wherein the coated surface area of said filtration medium particles as a percentage of total available coatable filtration media surface area is in the range of from about 0.25% to about 35%.

11. The device for treating irrigation water as recited in claim 8, wherein the amount of NSZV and/or MSZV metal coated on said filtration media as a percentage of the total of said NSZV and/or MSZV metal and said base filtration media is in the range of from about 0.2% to about 35%.

12. The device for treating irrigation water as recited in claim 8, wherein from about 0.5% to about 35.0% of the total filtration medium particles are coated partially or fully by NSZV and/or MSZV metal.

13. A process for treating irrigation water to remove microbiological impurities, comprising the steps of:
(A) contacting said irrigation water with filtration media, wherein said filtration media comprises a metal;
(B) using the treated irrigation water from step (A) for irrigation;
wherein said metal is selected from the group consisting of iron, aluminum, and combinations thereof.

14. The process for treating irrigation water as recited in claim 13, wherein said contacting of said irrigation water with said filtration media is accomplished by passing said irrigation water through a device for treating irrigation water, said device comprising a first end, a second end, and a hollow space formed in between said first end and said second end, wherein said hollow space comprises filtration media, wherein said filtration media comprises:
(A) optionally, a base filtration medium; and
(B) zero-valent metal, wherein said zero-valent metal comprises granular zero-valent metal, and/or at least a partial coating of particles said zero-valent metal on at least some of said base filtration medium;
wherein, said first end and said second end of said device comprise means for making a connection with an irrigation water delivery device and/or a sprinkler system, wherein said zero-valent metal is selected from the group consisting of iron, aluminum, and combinations thereof.

15. The process for treating irrigation water as recited in claim 14, wherein said metal is in contact with said irrigation water to be treated for a time of about 0.1 second or more.

16. The process for treating irrigation water as recited in claim 14, wherein said metal is capable of forming oxide, hydroxide, and/or oxyhydroxide.

17. The process for treating irrigation water as recited in claim 14, wherein said filtration media comprises said metal with an oxide, hydroxide, and/or oxyhydroxide coating.

18. The process for treating irrigation water as recited in claim 14, wherein said metal is zero-valent iron.

19. The process for treating irrigation water as recited in claim 14, wherein said base filtration medium is at least partially coated with NSZV and/or MSZV metal particles, wherein said NSZV metal particles are in a size range of from about 1 to about 1,000 nm and said MSZV metal particles are in a size range of from about 1 to about 200 micron.

20. The process for treating irrigation water as recited in claim 14, wherein said filtration media comprises a base filtration medium that is fully-coated with NSZV and/or MSZV particles.

20. The process for treating irrigation water as recited in claim 14, wherein said irrigation water comprises a virus and said treatment reduces said virus content by at least about 50%.

21. The process for treating irrigation water as recited in claim 14, wherein said irrigation water comprises bacteria and said treatment reduces said bacteria content by at least about 50%.

22. A process for reducing the use of a chemical disinfectant, irradiation, and/or filtration used to disinfect irrigation water, comprising, treating said irrigation water sought to be disinfected with (A) iron capable of forming an oxide, a hydroxide, and/or an oxyhydroxide, or (B) iron comprising an oxide, a hydroxide, and/or an oxyhydroxide such that said chemical disinfectant can be decreased and/or eliminated without a negative change in efficacy of said disinfection of said water.

23. A disinfection system for treating irrigation water to reduce microbiological impurities and DBP precursors, said disinfection system comprising:
(A) at least one device for treating irrigation water, said at least one device for treating irrigation water comprising a first end, a second end, and a hollow space formed in between said first end and said second end, wherein said hollow space comprises filtration media, wherein said filtration media comprises:
(I) optionally, a base filtration medium; and
(II) zero-valent metal, wherein said zero-valent metal comprises granular zero-valent metal, and/or at least a partial coating of particles of said zero-valent metal on at least some of said base filtration medium;
wherein, said first end and said second end of said device comprise means for making a connection with an irrigation water delivery device and/or a sprinkler system, wherein said zero-valent metal is selected from the group consisting of iron, aluminum, and combinations thereof;
(B) an irrigation water delivery device, and
(C) optionally, at least one sprinkler at the end of said at least one device for treating irrigation water from which treated irrigation water is dispensed on to the vegetation or field requiring irrigation water.

24. The disinfection system for treating irrigation water as recited in claim 23, wherein said base filtration medium is at least partially coated with NSZV and/or MSZV metal particles, wherein said NSZV metal particles are in a size range of from about 1 to about 1,000 nm, and said MSZV metal particles are in a size range of from about 1 to about 200 micron.

25. The disinfection system for treating irrigation water as recited in claim 23, wherein said filtration media comprises a base filtration medium that is fully-coated with NSZV and/or MSZV particles.

26. The system as recited in claim 24, wherein from about 0.5% to about 35% of all said filtration media particles by number in said system are at least partially coated with NSZV and/or MSZV metal.

27. The system as recited in claim 24, wherein said base filtration medium is partially-coated, and wherein the coated surface area of said filtration medium particles as a percentage of total available coatable filtration medium surface area of filtration medium particles in said system is in the range of from about 0.25% to about 35%.

28. The system as recited in claim 24, wherein the amount of said NSZV and/or MSZV metal coated on said filtration medium as a percentage of the total of said NSZV and/or MSZV metal and said base filtration medium in said system is in the range of from about 0.2% to about 35%.

29. The system as recited in claim 24, wherein said NSZV and/or MSZV metal is zero-valent iron.

30. The system as described in claim 23, wherein said disinfection system comprises more than one said device for treating irrigation water that are connected in series.

31. The system as described in claim 23, wherein said disinfection system comprises more than one said device for treating irrigation water that are connected in parallel, and wherein each said device for treating irrigation water is connected to a corresponding sprinkler.

32. The system as described in claim 23, wherein said system is a continuous-flow system or a batch system.

33. The system as recited in claim 23, wherein said system is portable.
